(19) United States
(12) Patent Application Publication
(10) Pub. No.: US 2026/0351173 A1
(43) Pub. Date: Nov. 5, 2026

(54) DISPLAY DEVICE AND ELECTRIC DEVICE INCLUDING THE SAME

(71) Applicant: Samsung Display Co., Ltd., Yongin-si (KR)

(72) Inventors: DONGJOO PARK, Yongin-si (KR); JEONG-YOUNG KIM, Yongin-si (KR); KIHAE SHIN, Yongin-si (KR)

(21) Appl. No.: 19/535,885

(22) Filed: Feb. 10, 2026

(30) Foreign Application Priority Data
May 2, 2025 (KR) 10-2025-0057967

(51) Int. Cl. G09G 3/3233; G09G 3/3275

(52) U.S. Cl. CPC G09G 3/3233; G09G 3/3275; G09G 2300/0819; G09G 2300/0852; G09G 2300/0861; G09G 2320/0233; G09G 2330/028

(57) ABSTRACT

A display device includes: a display panel comprising a pixel; a gate driver configured to provide a gate signal to the pixel; an emission driver configured to provide an emission signal to the pixel; a data driver configured to provide a data voltage to the pixel; a gamma voltage generation circuit configured to provide gamma voltages to the data driver; and a voltage control circuit configured to generate a compensated high gamma voltage, a compensated low gamma voltage, and a compensated reference voltage by compensating a high gamma voltage, a low gamma voltage, and a reference voltage based on a sensing power voltage measured at a power line configured to transmit a first power voltage, to provide the compensated high gamma voltage and the compensate low gamma voltage to the gamma voltage generation circuit, and to provide the compensated reference voltage to the pixel.

### CROSS-REFERENCE TO RELATED APPLICATION

The present application claims priority to and the benefit of Korean Patent Application No. 10-2025-0057967, filed on May 2, 2025, in the Korean Intellectual Property Office, the entire disclosure of which is incorporated herein by reference.

### BACKGROUND

### 1. Field

Aspects of some embodiments of the present disclosure relate to a display device.

### 2. Description of the Related Art

A display device may include a display panel including pixels, a data driver that provides a data voltage to each of the pixels, and a gamma voltage generation circuit that provides gamma voltages to the data driver. Each of the pixels may emit light based on at least one gate signal, at least one emission signal, and voltages including the data voltage and a first power voltage.

When noise occurs in the first power voltage, a difference between the first power voltage and the gamma voltages may change, and thus, a luminance of light emitted from the pixel may change. When the luminance of light emitted from the pixel changes due to the noise that occurs in the first power voltage, an image quality of the display device may deteriorate.

The above information disclosed in this Background section is only for enhancement of understanding of the background and therefore the information discussed in this Background section does not necessarily constitute prior art.

### SUMMARY

Aspects of some embodiments of the present disclosure relate to a display device. For example, aspects of some embodiments relate to a display device for compensating a gamma voltage and an electronic device including the display device.

Aspects of some embodiments of the present disclosure include a display device with a relatively improved image quality and an electronic device including the display device.

A display device according to some embodiments includes a display panel including a pixel, a gate driver that provides a gate signal to the pixel, an emission driver that provides an emission signal to the pixel, a data driver that provides a data voltage to the pixel, a gamma voltage generation circuit that provides gamma voltages to the data driver, and a voltage control circuit that generates a compensated high gamma voltage, a compensated low gamma voltage, and a compensated reference voltage by compensating a high gamma voltage, a low gamma voltage, and a reference voltage based on a sensing power voltage measured at a power line that transmits a first power voltage, provides the compensated high gamma voltage and the compensate low gamma voltage to the gamma voltage generation circuit, and provides the compensated reference voltage to the pixel.

According to some embodiments, the pixel may include a first transistor including a gate connected to a first node, a first terminal connected to a second node, and a second terminal connected to a third node, a second transistor that transmits the data voltage to a fourth node in response to a write gate signal, a first capacitor connected between the first node and the fourth node, a second capacitor connected between the fourth node and the power line, a third transistor that connects the first node to the third node in response to a compensation gate signal, a fourth transistor that transmits a first initialization voltage to the first node in response to an initialization gate signal, a fifth transistor that transmits the compensated reference voltage to the fourth node in response to the compensation gate signal, a sixth transistor that 1 connects the third node to a fifth node in response to a first emission signal, a seventh transistor that transmits a second initialization voltage to the fifth node in response to a bypass gate signal, and a light-emitting element including a first terminal connected to the fifth node and a second terminal that receives a second power voltage.

According to some embodiments, the pixel may further include an eighth transistor that transmits the first power voltage to the second node in response to a second emission signal.

According to some embodiments, the pixel may further include a ninth transistor that transmits a bias voltage to the second node in response to the bypass gate signal.

According to some embodiments, the voltage control circuit may include a subtractor that outputs a value obtained by subtracting a reference power voltage, which is a target voltage of the first power voltage, from the sensing power voltage as a power voltage offset, a first adder that outputs a value obtained by adding the power voltage offset to the high gamma voltage as the compensated high gamma voltage, a second adder that outputs a value obtained by adding the power voltage offset to the low gamma voltage as the compensated low gamma voltage, and a third adder that outputs a value obtained by adding the power voltage offset to the reference voltage as the compensated reference voltage.

According to some embodiments, the voltage control circuit may further include a digital-to-analog converter that generates the reference power voltage by digital-to-analog converting a reference power voltage code.

According to some embodiments, the voltage control circuit may further include a clamper that clamps the power voltage offset output from the subtractor based on a minimum offset and a maximum offset and outputs to the first adder, the second adder, and the third adder.

According to some embodiments, the voltage control circuit may be implemented as a power management integrated circuit.

According to some embodiments, the gamma voltage generation circuit may generate the gamma voltages by dividing the compensated high gamma voltage and the compensated low gamma voltage.

A display device according to some embodiments includes a display panel including a pixel, a gate driver that provides a gate signal to the pixel, an emission driver that provides an emission signal to the pixel, a data driver that provides a data voltage to the pixel, a gamma voltage generation circuit that provides gamma voltages to the data driver, a gamma voltage control circuit that generates a compensated high gamma voltage and a compensated low gamma voltage by compensating a high gamma voltage and a low gamma voltage based on a sensing power voltage measured at a power line that transmits a first power voltage and provides the compensated high gamma voltage and the compensate low gamma voltage to the gamma voltage generation circuit, and a reference voltage generation circuit that generates a compensated reference voltage based on the compensated high gamma voltage and provides the compensated reference voltage to the pixel.

According to some embodiments, the pixel may include a first transistor including a gate connected to a first node, a first terminal connected to a second node, and a second terminal connected to a third node, a second transistor that transmits the data voltage to a fourth node in response to a write gate signal, a first capacitor connected between the first node and the fourth node, a second capacitor connected between the fourth node and the power line, a third transistor that connects the first node to the third node in response to a compensation gate signal, a fourth transistor that transmits a first initialization voltage to the first node in response to an initialization gate signal, a fifth transistor that transmits the compensated reference voltage to the fourth node in response to the compensation gate signal, a sixth transistor that connects the third node to a fifth node in response to a first emission signal, a seventh transistor that transmits a second initialization voltage to the fifth node in response to a bypass gate signal, and a light-emitting element including a first terminal connected to the fifth node and a second terminal that receives a second power voltage.

According to some embodiments, the pixel may further include an eighth transistor that transmits the first power voltage to the second node in response to a second emission signal.

According to some embodiments, the pixel may further include a ninth transistor that transmits a bias voltage to the second node in response to the bypass gate signal.

According to some embodiments, the reference voltage generation circuit may include an operational amplifier including a first input terminal, a second input terminal, and an output terminal connected to the second input terminal and outputting the compensated reference voltage, a first resistor connected between an input terminal that receives the compensated high gamma voltage and the first input terminal of the operational amplifier, and a second resistor connected between the first input terminal of the operational amplifier and a ground.

According to some embodiments, the compensated reference voltage is calculated by

$$VREF = \frac{R 1}{R 1 + R 2} \times VGMHC$$

where, the VREF is the compensated reference voltage, the R1 is a resistance of the first resistor, the R2 is a resistance of the second resistor, and the VGMHC is the compensated high gamma voltage.

According to some embodiments, the gamma voltage control circuit may include a subtractor that outputs a value obtained by subtracting a reference power voltage, which is a target voltage of the first power voltage, from the sensing power voltage as a power voltage offset, a first adder that outputs a value obtained by adding the power voltage offset to the high gamma voltage as the compensated high gamma voltage, and a second adder that outputs a value obtained by adding the power voltage offset to the low gamma voltage as the compensated low gamma voltage.

According to some embodiments, the gamma voltage generation circuit may generate the gamma voltages by dividing the compensated high gamma voltage and the compensated low gamma voltage.

An electronic device according to some embodiments includes a processor that generates input image data, a display device that displays an image based on the input image data, and a power module connected to the processor and the display device. According to some embodiments, the display device includes a display panel including a pixel, a gate driver that provides a gate signal to the pixel, an emission driver that provides an emission signal to the pixel, a data driver that provides a data voltage to the pixel, a gamma voltage generation circuit that provides gamma voltages to the data driver, and a voltage control circuit that generates a compensated high gamma voltage, a compensated low gamma voltage, and a compensated reference voltage by compensating a high gamma voltage, a low gamma voltage, and a reference voltage based on a sensing power voltage measured at a power line that transmits a first power voltage, provides the compensated high gamma voltage and the compensate low gamma voltage to the gamma voltage generation circuit, and provides the compensated reference voltage to the pixel.

According to some embodiments, the pixel may include a first transistor including a gate connected to a first node, a first terminal connected to a second node, and a second terminal connected to a third node, a second transistor that transmits the data voltage to a fourth node in response to a write gate signal, a first capacitor connected between the first node and the fourth node, a second capacitor connected between the fourth node and the power line, a third transistor that connects the first node to the third node in response to a compensation gate signal, a fourth transistor that transmits a first initialization voltage to the first node in response to an initialization gate signal, a fifth transistor that transmits the compensated reference voltage to the fourth node in response to the compensation gate signal, a sixth transistor that connects the third node to a fifth node in response to a first emission signal, a seventh 1 transistor that transmits a second initialization voltage to the fifth node in response to a bypass gate signal, and a light-emitting element including a first terminal connected to the fifth node and a second terminal that receives a second power voltage.

According to some embodiments, the voltage control circuit may include a subtractor that outputs a value obtained by subtracting a reference power voltage, which is a target voltage of the first power voltage, from the sensing power voltage as a power voltage offset, a first adder that outputs a value obtained by adding the power voltage offset to the high gamma voltage as the compensated high gamma voltage, a second adder that outputs a value obtained by adding the power voltage offset to the low gamma voltage as the compensated low gamma voltage, and a third adder that outputs a value obtained by adding the power voltage offset to the reference voltage as the compensated reference voltage.

In the display device and the electronic device according to some embodiments, the compensated high gamma voltage, the compensated low gamma voltage, and the compensated reference voltage are generated by compensating the high gamma voltage, the low gamma voltage, and the reference voltage based on the sensing power voltage, so that a luminance of light emitted from the pixel may not change even if noise occurs in the first power voltage. Accordingly, the image quality of the display device may be relatively improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a display device according to some embodiments.

FIG. 2 is a circuit diagram illustrating a pixel of FIG. 1.

FIG. 3 is a timing diagram illustrating signals of FIG. 2.

FIG. 4 is a block diagram illustrating a voltage control circuit of FIG. 1.

FIG. 5 is a block diagram illustrating a display device according to some embodiments.

FIG. 6 is a block diagram illustrating a gamma voltage control circuit of FIG. 5.

FIG. 7 is a block diagram illustrating a reference voltage generation circuit of FIG. 5.

FIG. 8 is a block diagram illustrating an electronic device according to some embodiments.

FIG. 9 is a diagram illustrating electronic devices according to some embodiments.

### DETAILED DESCRIPTION

Hereinafter, aspects of a display device and an electronic device according to some embodiments of the present disclosure will be described in more detail with reference to the accompanying drawings. The same or similar reference numerals will be used for the same elements in the accompanying drawings.

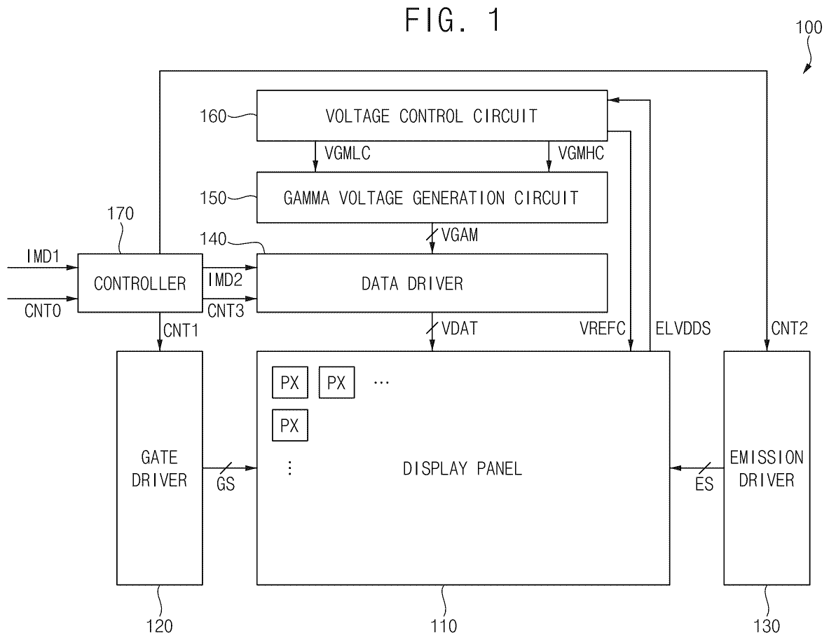

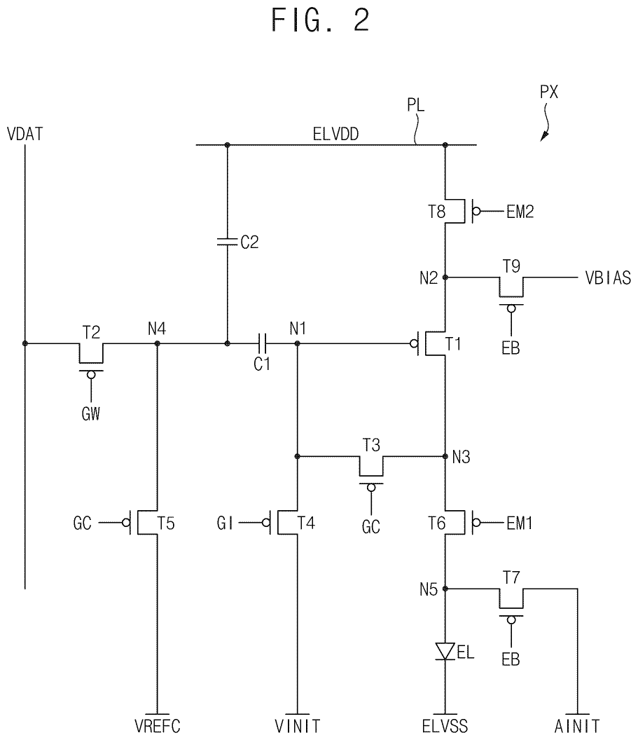

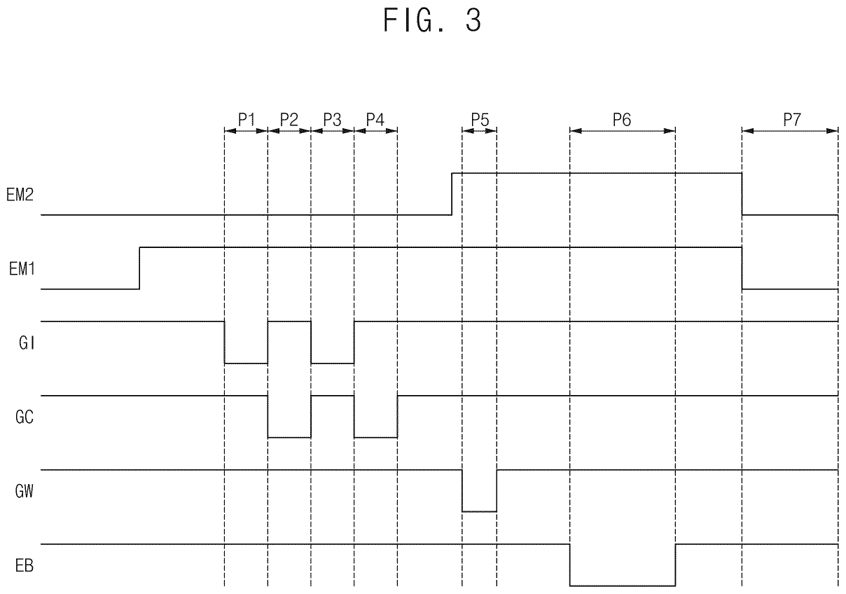

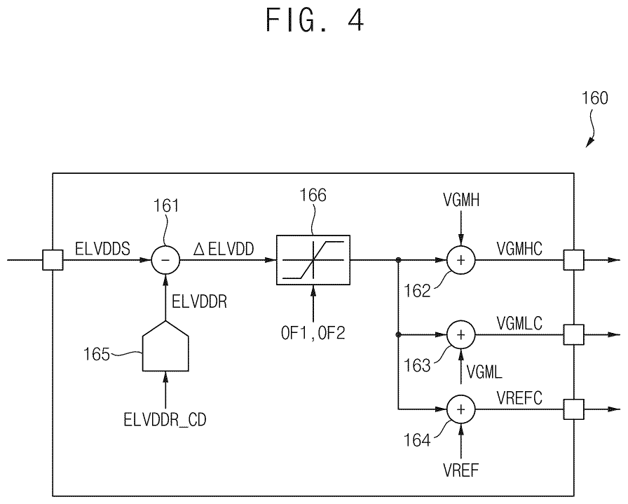

FIG. 1 is a block diagram illustrating a display device 100 according to some embodiments. FIG. 2 is a circuit diagram illustrating a pixel PX of FIG. 1. FIG. 3 is a timing diagram illustrating signals EM2, EM1, GI, GC, GW, and EB of FIG. 2. FIG. 4 is a block diagram illustrating a voltage control circuit 160 of FIG. 1.

Referring to FIGS. 1, 2, 3, and 4, a display device 100 according to some embodiments may include a display panel 110, a gate driver 120, an emission driver 130, a data driver 140, a gamma voltage generation circuit 150, a voltage control circuit 160, and a controller 170. Although FIGS. 1-4 illustrate various components in a display device according to some embodiments, embodiments according to the present disclosure are not limited thereto, and according to various embodiments, the display device 100 may include additional components, or fewer components, without departing from the spirit and scope of embodiments according to the present disclosure.

The display panel 110 may include pixels PX. According to some embodiments, the pixels PX may include red pixels that emit red light, green pixels that emit green light, and blue pixels that emit blue light. Although FIG. 2 illustrates various components in a pixel PX according to some embodiments, embodiments according to the present disclosure are not limited thereto, and according to various embodiments, the pixel PX may include additional components, or fewer components, without departing from the spirit and scope of embodiments according to the present disclosure.

Each of the pixels PX may emit light based on at least one gate signal GS, at least one emission signal ES, and voltages including a data voltage VDAT and a compensated reference voltage VREFC. According to some embodiments, each of the pixels PX may emit light based on a write gate signal GW, a compensation gate signal GC, an initialization gate signal GI, a first emission signal EM1, a second emission signal EM2, a bypass gate signal EB, the data voltage VDAT, a first power voltage ELVDD, a second power voltage ELVSS, the compensated reference voltage VREFC, a first initialization voltage VINIT, a second initialization voltage AINIT, and a bias voltage VBIAS.

Each of the pixels PX may include at least one transistor, at least one capacitor, and a light-emitting element EL. According to some embodiments, each of the pixels PX may include a first transistor T1, a second transistor T2, a first capacitor C1, a second capacitor C2, a third transistor T3, a fourth transistor T4, a fifth transistor T5, a sixth transistor T6, a seventh transistor T7, and the light-emitting element EL. According to some embodiments, each of the pixels PX may further include an eighth transistor T8 and a ninth transistor T9.

The first transistor T1 may generate a driving current based on a voltage difference between a first node N1 and a second node N2. The first transistor T1 may include a gate connected to the first node N1, a first terminal connected to the second node N2, and a second terminal connected to a third node N3.

The second transistor T2 may transmit the data voltage VDAT to a fourth node N4 in response to the write gate signal GW. The second transistor T2 may include a gate that receives the write gate signal GW, a first terminal that receives the data voltage VDAT, and a second terminal connected to the fourth node N4.

A first capacitor C1 may be connected between the first node N1 and the fourth node N4. The first capacitor C1 may include a first terminal connected to the first node N1 and a second terminal connected to the fourth node N4.

The second capacitor C2 may be connected between the fourth node N4 and a power line PL that transmits the first power voltage ELVDD. The second capacitor C2 may include a first terminal connected to the fourth node N4 and a second terminal connected to the power line PL.

The third transistor T3 may connect the first node N1 to the third node N3 in response to the compensation gate signal GC. The third transistor T3 may include a gate that receives the compensation gate signal GC, a first terminal connected to the first node N1, and a second terminal connected to the third node N3.

The fourth transistor T4 may transmit the first initialization voltage VINIT to the first node N1 in response to the initialization gate signal GI. The fourth transistor T4 may include a gate that receives the initialization gate signal GI, a first terminal that receives the first initialization voltage VINIT, and a second terminal connected to the first node N1.

The fifth transistor T5 may transmit the compensated reference voltage VREFC to the fourth node N4 in response to the compensation gate signal GC. The fifth transistor T5 may include a gate that receives the compensation gate signal GC, a first terminal that receives the compensated reference voltage VREFC, and a second terminal connected to the fourth node N4.

The sixth transistor T6 may connect the third node N3 to a fifth node N5 in response to the first emission signal EM1. The sixth transistor T6 may include a gate that receives the first emission signal EM1, a first terminal connected to the third node N3, and a second terminal connected to the fifth node N5.

The seventh transistor T7 may transmit the second initialization voltage AINIT to the fifth node N5 in response to the bypass gate signal EB. The seventh transistor T7 may include a gate that receives the bypass gate signal EB, a first terminal that receives the second initialization voltage AINIT, and a second terminal connected to the fifth node N5.

The light-emitting element EL may emit light based on the driving current generated by the first transistor T1. The light-emitting element EL may include a first terminal (e.g., an anode) connected to the fifth node N5 and a second terminal (e.g., a cathode) that receives the second power voltage ELVSS. According to some embodiments, the light-emitting element EL may be one of an organic light-emitting diode, an inorganic light-emitting diode, a quantum dot light-emitting diode, and a micro light-emitting diode.

The eighth transistor T8 may transmit the first power voltage ELVDD to the second node N2 in response to the second emission signal EM2. The eighth transistor T8 may include a gate that receives the second emission signal EM2, a first terminal connected to the power line PL, and a second terminal connected to the second node N2.

The ninth transistor T9 may transmit the bias voltage VBIAS to the second node N2 in response to the bypass gate signal EB. The ninth transistor T9 may include a gate that receives the bypass gate signal EB, a first terminal that receives the bias voltage VBIAS, and a second terminal connected to the second node N2.

In a first period P1, the first initialization voltage VINIT may be applied to the first node N1 through the fourth transistor T4 turned on in response to the initialization gate signal GI. Accordingly, in the first period P1, the first transistor T1 may be turned on.

In a second period P2, a value ELVDD-VTH obtained by subtracting a threshold voltage VTH of the first transistor T1 from the first power voltage ELVDD may be applied to the first node N1 through the eighth transistor T8 turned on in response to the second emission signal EM2, the turned-on first transistor T1, and the third transistor T3 turned on in response to the compensation gate signal GC. In the second period P2, the compensated reference voltage VREFC may be applied to the fourth node N4 through the fifth transistor T5 turned on in response to the compensation gate signal GC, and a voltage of the fourth node N4 may change from the data voltage VDAT′ of a previous frame period to the compensated reference voltage VREFC. In the second period P2, due to a coupling effect of the first capacitor C1, a voltage of the first node N1 may become ELVDD-VTH+VREFC-VDAT′.

In a third period P3, the first initialization voltage VINIT may be applied to the first node N1 through the fourth transistor T4 turned on in response to the initialization gate signal GI. Accordingly, in the third period P3, the first transistor T1 may be turned on.

In a fourth period P4, a value ELVDD-VTH obtained by subtracting the threshold voltage VTH of the first transistor T1 from the first power voltage ELVDD may be applied to the first node N1 through the eighth transistor T8 turned on in response to the second emission signal EM2, the turned-on first transistor T1, and the third transistor T3 turned on in response to the compensation gate signal GC. In the fourth period P4, the compensated reference voltage VREFC may be applied to the fourth node N4 through the fifth transistor T5 turned on in response to the compensation gate signal GC, and the voltage of the fourth node N4 may not change. Because the voltage of the fourth node N4 does not change in the fourth period P4, the voltage of the first node N1 may maintain as ELVDD-VTH.

In a fifth period P5, the data voltage VDAT may be applied to the fourth node N4 through the second transistor T2 turned on in response to the write gate signal GW, and the voltage of the fourth node N4 may change from the compensated reference voltage VREFC to the data voltage VDAT. In the fifth period P5, due to the coupling effect of the first capacitor C1, the voltage of the first node N1 may become ELVDD-VTH+VDAT-VREFC.

In a sixth period P6, the second initialization voltage AINIT may be applied to the fifth node N5 through the seventh transistor T7 turned on in response to the bypass gate signal EB. In the sixth period P6, the bias voltage VBIAS may be applied to the second node N2 through the ninth transistor T9 turned on in response to the bypass gate signal EB.

In a seventh period P7, a current path may be formed through the eighth transistor T8 turned on in response to the second emission signal EM2, the turned-on first transistor T1, the sixth transistor T6 turned on in response to the first emission signal EM1, and the light-emitting element EL, and the driving current IEL generated by the first transistor T1 may flow through the current path. The driving current IEL may be calculated by the following Mathematical Formula 1.

$$IEL = K \times {( VSG - VTH )}^{2} = K \times {( ELVDD - ( ELVDD - VTH + VDAT - VREFC ) - VTH )}^{2} = K \times {( VREFC - VDAT )}^{2} \qquad Mathematical Formula 1$$

where, K is a proportional constant, and VSG is a voltage difference between the first terminal and the gate of the first transistor T1. According to Mathematical Formula 1, the driving current IEL may be determined by the compensated reference voltage VREFC and the data voltage VDAT regardless of the threshold voltage VTH of the first transistor T1. In the seventh period P7, the light-emitting element EL may emit light with a luminance corresponding to a difference between the compensated reference voltage VREFC and the data voltage VDAT.

The gate driver 120 may provide at least one gate signal GS to each of the pixels PX. According to some embodiments, the gate signal GS may include the write gate signal GW, the compensation gate signal GC, and the initialization gate signal GI. The gate driver 120 may generate the gate signal GS based on a first control signal CNT1. The first control signal CNT1 may include a gate start signal, a gate clock signal, and the like.

The emission driver 130 may provide at least one emission signal ES to each of the pixels PX. According to some embodiments, the emission signal ES may include the first emission signal EM1, the second emission signal EM2, and the bypass gate signal EB. The emission driver 130 may generate the emission signal ES based on a second control signal CNT2. The second control signal CNT2 may include an emission start signal, an emission clock signal, and the like.

The data driver 140 may provide the data voltage VDAT to each of the pixels PX. The data driver 140 may generate the data voltage VDAT based on output image data IMD2, gamma voltages VGAM, and a third control signal CNT3. The output image data IMD2 may include a grayscale value. The data driver 140 may select a gamma voltage corresponding to the grayscale value among the gamma voltages VGAM as the data voltage VDAT. The third control signal CNT3 may include a load signal, a data clock signal, an output data enable signal, and the like.

The gamma voltage generation circuit 150 may provide the gamma voltages VGAM to the data driver 140. The gamma voltage generation circuit 150 may generate the gamma voltages VGAM based on a compensated high gamma voltage VGMHC and a compensated low gamma voltage VGMLC. According to some embodiments, the gamma voltage generation circuit 150 may generate the gamma voltages VGAM by dividing the compensated high gamma voltage VGMHC and the compensated low gamma voltage VGMLC. The compensated high gamma voltage VGMHC may be a maximum voltage among the gamma voltages VGAM, and the compensated low 1 gamma voltage VGMLC may be a minimum voltage among the gamma voltages VGAM.

The voltage control circuit 160 may provide the compensated high gamma voltage VGMHC and the compensated low gamma voltage VGMLC to the gamma voltage generation circuit 150, and may provide the compensated reference voltage VREFC to each of the pixels PX. The voltage control circuit 160 may compensate a high gamma voltage VGMH, a low gamma voltage VGML, and a reference voltage VREF based on a sensing power voltage ELVDDS to generate the compensated high gamma voltage VGMHC, the compensated low gamma voltage VGMLC, and the compensated reference voltage VREFC. The sensing power voltage ELVDDS may be measured at the power line PL that transmits the first power voltage ELVDD.

According to some embodiments, the voltage control circuit 160 may include a subtractor 161, a first adder 162, a second adder 163, and a third adder 164. According to some embodiments, the voltage control circuit 160 may further include a digital-to-analog converter 165 and a clamper 166.

The subtractor 161 may output a value obtained by subtracting a reference power voltage ELVDDR from the sensing power voltage ELVDDS as a power voltage offset ΔELVDD. The reference power voltage ELVDDR may be a target voltage of the first power voltage ELVDD.

The first adder 162 may output a value obtained by adding the power voltage offset ΔELVDD to the high gamma voltage VGMH as the compensated high gamma voltage VGMHC. The second adder 163 may output a value obtained by adding the power voltage offset ΔELVDD to the low gamma voltage VGML as the compensated low gamma voltage VGMLC. The third adder 164 may output a value obtained by adding a power voltage offset ΔELVDD to a reference voltage VREF as the compensated reference voltage VREFC.

The digital-to-analog converter 165 may digital-to-analog convert a reference power voltage code ELVDDR_CD to generate the reference power voltage ELVDDR. According to some embodiments, the reference power voltage code ELVDDR_CD may be stored in a register.

The clamper 166 may clamp the power voltage offset ΔELVDD output from the subtractor 161 based on a minimum offset OF1 and a maximum offset OF2, and may output the clamped result to the first adder 162, the second adder 163, and the third adder 164. The clamper 166 may output the minimum offset OF1 as the power voltage offset ΔELVDD when the power voltage offset ΔELVDD is less than the minimum offset OF1, and may output the maximum offset OF2 as the power voltage offset ΔELVDD when the power voltage offset ΔELVDD is greater than the maximum offset OF2.

According to some embodiments, the voltage control circuit 160 may be implemented as a power management integrated circuit (PMIC).

When noise, such as ripple, occurs in the first power voltage ELVDD, the first power voltage ELVDD may change. When a difference between the first power voltage ELVDD and the data voltage VDAT changes, a luminance of light emitted from the pixel PX may change, and an image quality of the display device may deteriorate. Accordingly, in the prior art, adaptive voltage compensation AVC is used to compensate for the high gamma voltage VGMH and the low gamma voltage VGML in response to changes in the first power voltage ELVDD, and accordingly, the image quality of the display device is compensated. However, in the pixel PX of FIG. 2 according to the prior art, the light-emitting element EL may emit light with a luminance corresponding to the difference between the reference voltage VREF and the data voltage VDAT, and in the prior art, only the high gamma voltage VGMH and the low gamma voltage VGML are compensated, and the reference voltage VREF is not compensated. Accordingly, in the prior art, when noise occurs in the first power voltage ELVDD, because only the data voltage VDAT changes in response to changes in the first power voltage ELVDD and the reference voltage VREF does not change, the luminance of the light emitted from the pixel PX may change, and the image quality of 1 the display device may deteriorate. However, in the display device 100 according to some embodiments, the voltage control circuit 160 compensates the high gamma voltage VGMH, the low gamma voltage VGML, and the reference voltage VREF based on the sensing power voltage ELVDDS to generate the compensated high gamma voltage VGMHC, the compensated low gamma voltage VGMLC, and the compensated reference voltage VREFC, so that even if noise occurs in the first power voltage ELVDD, a difference between the compensated reference voltage VREFC and the data voltage VDAT may not change. Accordingly, even if noise occurs in the first power voltage ELVDD, the luminance of the light emitted from the pixel PX may not change, and the image quality of the display device 100 may be relatively improved.

The controller 170 may control the gate driver 120, the emission driver 130, and the data driver 140. The controller 170 may provide the first control signal CNT1 to the gate driver 120, may provide the second control signal CNT2 to the emission driver 130, and may provide the output image data IMD2 and the third control signal CNT3 to the data driver 140. The controller 170 may generate the output image data IMD2, the first control signal CNT1, the second control signal CNT2, and the third control signal CNT3 based on input image data IMD1 and a control signal CNT0. According to some embodiments, the input image data IMD1 may include red image data, green image data, and blue image data. The control signal CNT0 may include a vertical synchronization signal, a vertical synchronization signal, a master clock signal, an input data enable signal, and the like.

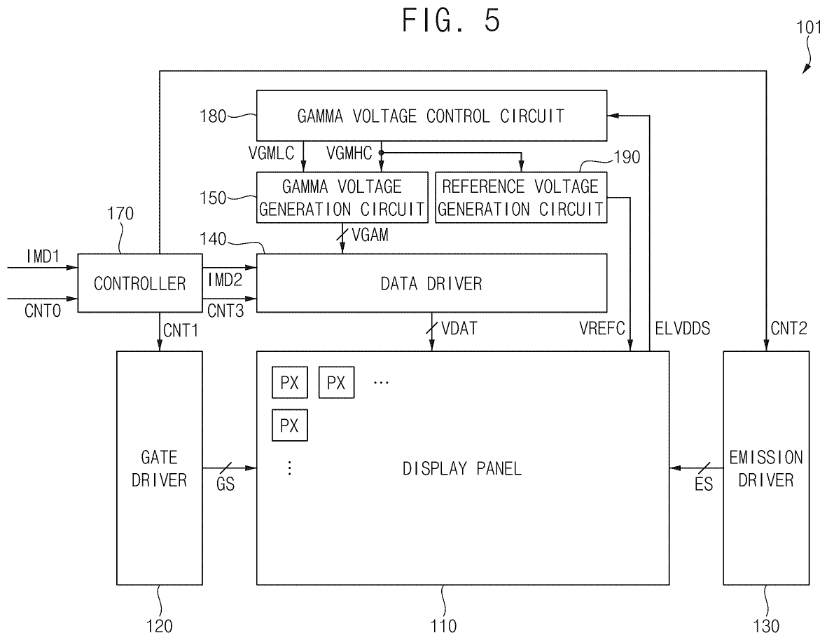

FIG. 5 is a block diagram illustrating a display device 101 according to some embodiments. Although FIG. 5 illustrates various components in a display device according to some embodiments, embodiments according to the present disclosure are not limited thereto, and according to various embodiments, the display device may include additional components, or fewer components, without departing from the spirit and scope of embodiments according to the present disclosure.

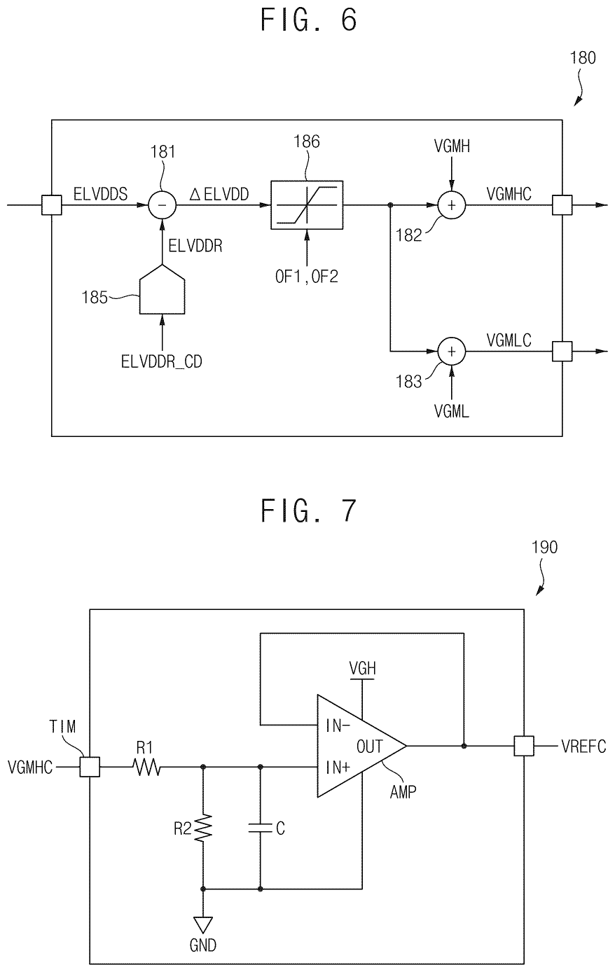

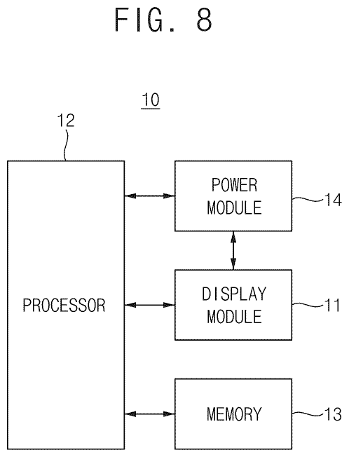

FIG. 6 is a block diagram illustrating a gamma voltage control circuit 180 of FIG. 5. FIG. 7 is a block diagram illustrating a reference voltage generation circuit 190 of FIG. 5.

Referring to FIGS. 5, 6, and 7, a display device 101 according to some embodiments may include a display panel 110, a gate driver 120, an emission driver 130, a data driver 140, a gamma voltage generation circuit 150, a gamma voltage control circuit 180, a reference voltage generation circuit 190, and a controller 170. Descriptions of components of the display device 101 described with reference to FIGS. 5 to 7, which are substantially the same as or similar to those of the display device 100 described with reference to FIGS. 1 to 4, are omitted.

The gamma voltage control circuit 180 may provide a compensated high gamma voltage VGMHC and a compensated low gamma voltage VGMLC to the gamma voltage generation circuit 150. The gamma voltage control circuit 180 may compensate a high gamma voltage VGMH and a low gamma voltage VGML based on a sensing power voltage ELVDDS to generate the compensated high gamma voltage VGMHC and the compensated low gamma voltage VGMLC.

According to some embodiments, the gamma voltage control circuit 180 may include a subtractor 181, a first adder 182, and a second adder 183. According to some embodiments, the gamma voltage control circuit 180 may further include a digital-to-analog converter 185 and a clamper 186.

The subtractor 181 may output a value obtained by subtracting a reference power voltage ELVDDR from the sensing power voltage ELVDDS as a power voltage offset ΔELVDD.

The first adder 182 may output a value obtained by adding the power voltage offset ΔELVDD to the high gamma voltage VGMH as the compensated high gamma voltage VGMHC. The second adder 183 may output a value obtained by adding the power voltage offset ΔELVDD to the low gamma voltage VGML as the compensated low gamma voltage VGMLC.

The digital-to-analog converter 185 may digital-to-analog convert a reference power voltage code ELVDDR_CD to generate the reference power voltage ELVDDR. The clamper 186 may clamp the power voltage offset ΔELVDD output from the subtractor 181 based on a minimum offset OF1 and a maximum offset OF2, and may output the clamped result to the first adder 182 and the second adder 183.

According to some embodiments, the gamma voltage control circuit 180 may be implemented as a power management integrated circuit (PMIC).

The reference voltage generation circuit 190 may provide a compensated reference voltage VREFC to each of the pixels PX. The reference voltage generation circuit 190 may generate the compensated reference voltage VREFC based on the compensated high gamma voltage VGMHC.

According to some embodiments, the reference voltage generation circuit 190 may include an operational amplifier AMP, a first resistor R1, a second resistor R2, and a capacitor C.

The operational amplifier AMP may include a first input terminal IN+, a second input terminal IN−, and an output terminal OUT that outputs the compensated reference voltage VREFC. The output terminal OUT may be connected to the second input terminal IN−. Accordingly, negative feedback may be applied to the operational amplifier AMP.

The first resistor R1 may be connected between an input terminal TIM that receives the compensation high gamma voltage VGHC and the first input terminal IN+ of the operational amplifier AMP. The first resistor R1 may include a first terminal connected to the input terminal TIM and a second terminal connected to the first input terminal IN+ of the operational amplifier AMP.

The second resistor R2 may be connected between the first input terminal IN+ of the operational amplifier AMP and a ground GND. The second resistor R2 may include a first terminal connected to the first input terminal IN+ of the operational amplifier AMP and a second terminal connected to the ground GND.

A capacitor C may be connected between the first input terminal IN+ of the operational amplifier AMP and the ground GND. The capacitor C may include a first terminal connected to the first input terminal IN+ of the operational amplifier AMP and a second terminal connected to the ground GND. In other words, the capacitor C may be connected in parallel with the second resistor R2.

The compensated reference voltage VREFC may be calculated by mathematical formula 2.

$$VREF = \frac{R 1}{R 1 + R 2} \times VGMHC \qquad Mathematical Formula 2$$

In mathematical formula 2, R1 represents a resistance of the first resistor R1, and R2 represents a resistance of the second resistor R2. According to mathematical formula 2, the compensated reference voltage VREFC may be proportional to the compensated high gamma voltage VGHC. Accordingly, the reference voltage generation circuit 190 may generate the compensated reference voltage VREFC compensated to correspond to the compensated high gamma voltage VGHC compensated by the gamma voltage control circuit 180.

According to some embodiments, the reference voltage generation circuit 190 may be implemented as an external circuit separate from the gamma voltage control circuit 180 implemented as the power management integrated circuit (PMIC).

FIG. 8 is a block diagram illustrating an electronic device 10 according to some embodiments.

Referring to FIG. 8, an electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The memory 13 may store data information necessary for an operation of the processor 12 or the display module 11. When the processor 12 executes an application 1 stored in the memory 13, the input image data IMD1 of FIG. 1 and the control signal CNT0 of FIG. 1 may be transmitted to the display module 11, and the display module 11 may output image information based on the input image data IMD1 and the control signal CNT0.

The power module 14 may include a power supply module such as a power adapter, a battery device, etc. and a power conversion module that converts power supplied by the power supply module to generate power required for an operation of the electronic device 10.

At least one of the components of the electronic device 10 described above may be included in the display device 100 of FIG. 1 or 101 of FIG. 5 according to the embodiments described above. Further, some of individual modules functionally included in one module may be included in the display device 100 or 101, and others may be provided separately from the display device 100 or 101. For example, the display device 100 or 101 may include the display module 11, and the processor 12, the memory 13, and the power module 14 may be provided in the form of other devices within the electronic device 10 other than the display device 100 or 101.

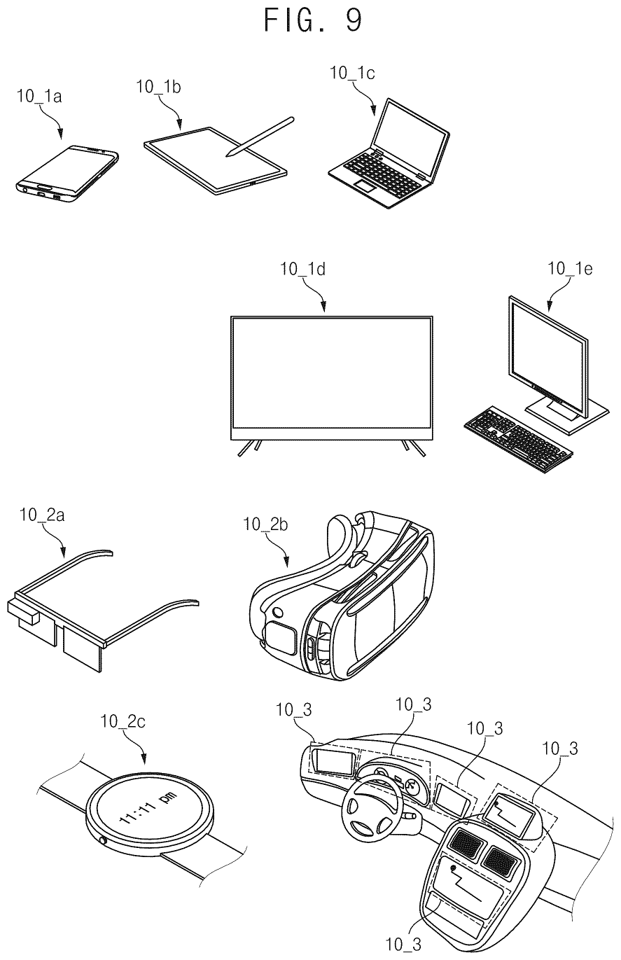

FIG. 9 is a diagram illustrating electronic devices according to some embodiments.

Referring to FIG. 9, electronic devices to which display devices according to some embodiments are applied may include not only image display electronic devices such as a smart phone 10_1a, a tablet PC 10_1b, a laptop 10_1c, a TV 10_1d, a desk monitor 10_1e, etc. but also wearable electronic devices including display modules such as smart glasses 10_2a, a head mounted display 10_2b, a smart watch 10_2c, etc., vehicle electronic devices 10_3 including display modules such as an instrument panel of an automobile, a center fascia, a center information display CID arranged on a dashboard, a room mirror display, etc.

The display device according to the embodiments may be applied to a display device included in a computer, a notebook, a mobile phone, a smart phone, a smart pad, a smart watch, a PMP, a PDA, an MP3 player, or the like.

Although aspects of a display device and an electronic device including the same, according to some embodiments, have been described with reference to the drawings, the illustrated embodiments are examples, and may be modified and changed by a person having ordinary knowledge in the relevant technical field without departing from the technical spirit described in the following claims, and their equivalents.

What is claimed is:

1. A display device, comprising:
a display panel comprising a pixel;
a gate driver configured to provide a gate signal to the pixel;
an emission driver configured to provide an emission signal to the pixel;
a data driver configured to provide a data voltage to the pixel;
a gamma voltage generation circuit configured to provide gamma voltages to the data driver; and
a voltage control circuit configured to generate a compensated high gamma voltage, a compensated low gamma voltage, and a compensated reference voltage by compensating a high gamma voltage, a low gamma voltage, and a reference voltage based on a sensing power voltage measured at a power line configured to transmit a first power voltage, to provide the compensated high gamma voltage and the compensate low gamma voltage to the gamma voltage generation circuit, and to provide the compensated reference voltage to the pixel.

2. The display device of claim 1, wherein the pixel comprises:
a first transistor comprising a gate connected to a first node, a first terminal connected to a second node, and a second terminal connected to a third node;
a second transistor configured to transmit the data voltage to a fourth node in response to a write gate signal;
a first capacitor connected between the first node and the fourth node;
a second capacitor connected between the fourth node and the power line;
a third transistor configured to connect the first node to the third node in response to a compensation gate signal;
a fourth transistor configured to transmit a first initialization voltage to the first node in response to an initialization gate signal;
a fifth transistor configured to transmit the compensated reference voltage to the fourth node in response to the compensation gate signal;
a sixth transistor configured to connect the third node to a fifth node in response to a first emission signal;
a seventh transistor configured to transmit a second initialization voltage to the fifth node in response to a bypass gate signal; and
a light-emitting element comprising a first terminal connected to the fifth node and a second terminal configured to receive a second power voltage.

3. The display device of claim 2, wherein the pixel further comprises:
an eighth transistor configured to transmit the first power voltage to the second node in response to a second emission signal.

4. The display device of claim 2, wherein the pixel further comprises:
a ninth transistor configured to transmit a bias voltage to the second node in response to the bypass gate signal.

5. The display device of claim 1, wherein the voltage control circuit comprises:
a subtractor configured to output a value obtained by subtracting a reference power voltage, which is a target voltage of the first power voltage, from the sensing power voltage as a power voltage offset;
a first adder configured to output a value obtained by adding the power voltage offset to the high gamma voltage as the compensated high gamma voltage;
a second adder configured to output a value obtained by adding the power voltage offset to the low gamma voltage as the compensated low gamma voltage; and
a third adder configured to output a value obtained by adding the power voltage offset to the reference voltage as the compensated reference voltage.

6. The display device of claim 5, wherein the voltage control circuit further comprises:
a digital-to-analog converter configured to generate the reference power voltage by digital-to-analog converting a reference power voltage code.

7. The display device of claim 5, wherein the voltage control circuit further comprises:
a clamper configured to clamp the power voltage offset output from the subtractor based on a minimum offset and a maximum offset and to output to the first adder, the second adder, and the third adder.

8. The display device of claim 1, wherein the voltage control circuit is implemented as a power management integrated circuit.

9. The display device of claim 1, wherein the gamma voltage generation circuit is configured to generate the gamma voltages by dividing the compensated high gamma voltage and the compensated low gamma voltage.

10. A display device, comprising:
a display panel comprising a pixel;
a gate driver configured to provide a gate signal to the pixel;
an emission driver configured to provide an emission signal to the pixel;
a data driver configured to provide a data voltage to the pixel;
a gamma voltage generation circuit configured to provide gamma voltages to the data driver;
a gamma voltage control circuit configured to generate a compensated high gamma voltage and a compensated low gamma voltage by compensating a high gamma voltage and a low gamma voltage based on a sensing power voltage measured at a power line configured to transmit a first power voltage and to provide the compensated high gamma voltage and the compensate low gamma voltage to the gamma voltage generation circuit; and
a reference voltage generation circuit configured to generate a compensated reference voltage based on the compensated high gamma voltage and to provide the compensated reference voltage to the pixel.

11. The display device of claim 10, wherein the pixel comprises:
a first transistor comprising a gate connected to a first node, a first terminal connected to a second node, and a second terminal connected to a third node;
a second transistor configured to transmit the data voltage to a fourth node in response to a write gate signal;
a first capacitor connected between the first node and the fourth node;
a second capacitor connected between the fourth node and the power line;
a third transistor configured to connect the first node to the third node in response to a compensation gate signal;
a fourth transistor configured to transmit a first initialization voltage to the first node in response to an initialization gate signal;
a fifth transistor configured to transmit the compensated reference voltage to the fourth node in response to the compensation gate signal;
a sixth transistor configured to connect the third node to a fifth node in response to a first emission signal;
a seventh transistor configured to transmit a second initialization voltage to the fifth node in response to a bypass gate signal; and
a light-emitting element comprising a first terminal connected to the fifth node and a second terminal configured to receive a second power voltage.

12. The display device of claim 11, wherein the pixel further comprises:
an eighth transistor configured to transmit the first power voltage to the second node in response to a second emission signal.

13. The display device of claim 11, wherein the pixel further comprises:
a ninth transistor configured to transmit a bias voltage to the second node in response to the bypass gate signal.

14. The display device of claim 10, wherein the reference voltage generation circuit comprises:
an operational amplifier comprising a first input terminal, a second input terminal, and an output terminal connected to the second input terminal and configured to output the compensated reference voltage;
a first resistor connected between an input terminal configured to receive the compensated high gamma voltage and the first input terminal of the operational amplifier; and
a second resistor connected between the first input terminal of the operational amplifier and a ground.

15. The display device of claim 14, wherein the compensated reference voltage is calculated by
$$VREF = \frac{R 1}{R 1 + R 2} \times VGMHC$$
where, the VREF is the compensated reference voltage, the R1 is a resistance of the first resistor, the R2 is a resistance of the second resistor, and the VGMHC is the compensated high gamma voltage.

16. The display device of claim 10, wherein the gamma voltage control circuit comprises:
a subtractor configured to output a value obtained by subtracting a reference power voltage, which is a target voltage of the first power voltage, from the sensing power voltage as a power voltage offset;
a first adder configured to output a value obtained by adding the power voltage offset to the high gamma voltage as the compensated high gamma voltage; and
a second adder configured to output a value obtained by adding the power voltage offset to the low gamma voltage as the compensated low gamma voltage.

17. The display device of claim 10, wherein the gamma voltage generation circuit is configured to generate the gamma voltages by dividing the compensated high gamma voltage and the compensated low gamma voltage.

18. An electronic device, comprising:
a processor configured to generate input image data;
a display device configured to display an image based on the input image data; and
a power module connected to the processor and the display device,
wherein the display device comprises:
a display panel comprising a pixel;
a gate driver configured to provide a gate signal to the pixel;
an emission driver configured to provide an emission signal to the pixel;
a data driver configured to provide a data voltage to the pixel;
a gamma voltage generation circuit configured to provide gamma voltages to the data driver; and
a voltage control circuit configured to generate a compensated high gamma voltage, a compensated low gamma voltage, and a compensated reference voltage by compensating a high gamma voltage, a low gamma voltage, and a reference voltage based on a sensing power voltage measured at a power line configured to transmit a first power voltage, to provide the compensated high gamma voltage and the compensate low gamma voltage to the gamma voltage generation circuit, and to provide the compensated reference voltage to the pixel.

19. The electronic device of claim 18, wherein the pixel comprises:
a first transistor comprising a gate connected to a first node, a first terminal connected to a second node, and a second terminal connected to a third node;
a second transistor configured to transmit the data voltage to a fourth node in response to a write gate signal;
a first capacitor connected between the first node and the fourth node;
a second capacitor connected between the fourth node and the power line;
a third transistor configured to connect the first node to the third node in response to a compensation gate signal;
a fourth transistor configured to transmit a first initialization voltage to the first node in response to an initialization gate signal;
a fifth transistor configured to transmit the compensated reference voltage to the fourth node in response to the compensation gate signal;
a sixth transistor configured to connect the third node to a fifth node in response to a first emission signal;
a seventh transistor configured to transmit a second initialization voltage to the fifth node in response to a bypass gate signal; and
a light-emitting element comprising a first terminal connected to the fifth node and a second terminal configured to receive a second power voltage.

20. The electronic device of claim 18, wherein the voltage control circuit comprises:
a subtractor configured to output a value obtained by subtracting a reference power voltage, which is a target voltage of the first power voltage, from the sensing power voltage as a power voltage offset;
a first adder configured to output a value obtained by adding the power voltage offset to the high gamma voltage as the compensated high gamma voltage;
a second adder configured to output a value obtained by adding the power voltage offset to the low gamma voltage as the compensated low gamma voltage; and
a third adder configured to output a value obtained by adding the power voltage offset to the reference voltage as the compensated reference voltage.
